(19) United States
(12) Patent Application Publication
(10) Pub. No.: US 2017/0202200 A1
(43) Pub. Date: Jul. 20, 2017

(54) SYSTEMS AND METHODS FOR INSECT TRAPPING AND DETECTION

(71) Applicant: High 5 Innovation Ltd., Cincinnati, OH (US)

(72) Inventors: Thomas C. Hortel, Cincinnati, OH (US); Michael D. Mullins, Fairfield, OH (US)

(21) Appl. No.: 15/480,165

(22) Filed: Apr. 5, 2017

Related U.S. Application Data
(63) Continuation of application No. 14/320,809, filed on Jul. 1, 2014, now abandoned.
(60) Provisional application No. 61/842,755, filed on Jul. 3, 2013.

(51) Int. Cl. A01M 1/02; A01M 1/10; A01M 1/20; A01M 1/14

(52) U.S. Cl. CPC A01M 1/023; A01M 1/14; A01M 1/103; A01M 1/2011; A01M 1/026

(57) ABSTRACT

An insect trap can include a ramp, a planar surface that can include a coating of pressure sensitive adhesive, and one or a plurality of attractant elements, the attractant elements containing a carbon dioxide generating material.

### REFERENCE TO RELATED APPLICATION

The present application is a continuation of U.S. patent application Ser. No. 14/320,809, filed on Jul. 1, 2014, which claims priority to U.S. provisional patent application Ser. No. 61/842,755, filed Jul. 7, 2013, and are hereby incorporated by reference in their entirety.

### TECHNICAL FIELD

Embodiments of the technology relate, in general, to insect detection technology, and in particular to systems and methods for effective monitoring and trapping of insect populations.

### BACKGROUND

The bed bug, Cimex lectularius of the Family Cimicidae, has been a blood-sucking pest for many generations. The adult bed bug's key features are a length of 6-9 mm, with a flattened, oval, wingless shape and reddish-brown color. They lack tarsal pads and are required to climb vertical surfaces using tarsal hooks that they embed in suitably rough material. Bed bugs are primarily active at night but are not considered to be exclusively nocturnal. They hide in unnoticed crevices and fabric seams which make their detection difficult.

Most U.S. homeowners of the last generation have not had to deal with bed bugs due to the widespread use of DDT in the 1940s and 1950s as well as other pesticides in later years. However, the effectiveness of DDT and other pesticides was quickly reduced as bed bugs became resistant to each pesticide as the use of each became more prevalent. The resistance to pesticides among bed bug populations has caused a resurgence in bed bugs and dramatically increased infestations, especially in hotels, resorts, college dormitories, and apartments.

### SUMMARY

An insect trap can include a first planar surface, the first planar surface having a retention flap and a flange, where the first planar surface, the retention flap, and the flange can cooperate to define a pouch. The insect trap can include a second planar surface, the second planar surface being substantially parallel to the first planar surface, where at least a portion of the second planar surface can include a coating of pressure sensitive adhesive. The insect trap can include a plurality of spacers, the spacers being positioned between the first planar surface and the second planar surface such that the first planar surface and the second planar surface are spaced apart, and an attractant pad, the attractant pad containing a carbon dioxide generating material, where the attractant pad can be selectively removable from the pouch.

An insect trap can include a first planar surface and a second planar surface, the second planar surface being substantially parallel to the first planar surface, where at least a portion of the second planar surface can include a coating of pressure sensitive adhesive. The insect trap can include a plurality of attractant pads, the plurality of attractant pads being positioned between the first planar surface and the second planar surface such that the first planar surface and the second planar surface are spaced apart, where the plurality of attractant pads contain a carbon dioxide generating material.

### BRIEF DESCRIPTION OF THE DRAWINGS

The present disclosure will be more readily understood from a detailed description of some example embodiments taken in conjunction with the following figures:

FIG. 1 depicts a side view of an example insect trap system.

FIG. 2 depicts an exploded view of the insect trap system shown in FIG. 1.

FIG. 3 depicts a top view of an optically clear insect trap system according to an alternate embodiment.

FIG. 4 depicts a side view of the insect trap shown in FIG. 3.

FIG. 5 depicts a perspective view of a manufacturing process for the insect trap system shown in FIG. 3 according to one embodiment.

FIG. 6 depicts a perspective view of an insect barrier according to one embodiment.

FIG. 7 depicts a top view of the insect barrier shown in FIG. 6.

FIG. 8 depicts an exploded view of an insect trap system according to an alternate embodiment.

FIG. 9 depicts an exploded view of an insect trap system according to an alternate embodiment.

FIG. 10 depicts a side cross-sectional view of the insect trap system shown in FIG. 9, further illustrating how carbon dioxide gas can pass through the system.

FIG. 11 depicts a partial exploded view of an insect trap system according to an alternate embodiment.

FIG. 12 depicts a method of manufacturing the insect trap system shown in FIG. 11 according to one embodiment.

FIG. 13 depicts a perspective view of an insect trap system according to an alternate embodiment.

FIG. 14 depicts a perspective view of an insect trap system according to an alternate embodiment.

FIG. 15 depicts a cross-sectional view of the insect trap system shown in FIG. 14.

FIG. 16 depicts an exploded view of the insect trap system shown in FIG. 14.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Insect infestations (e.g., bedbugs) are undergoing a huge resurgence around the globe and there is a need for an effective monitoring system that can allow for the early detection of bedbugs (or other insect pests) before the insect populations have a chance to become well established and begin to spread. Example embodiments of traps, detectors, or monitors can, for example, allow residents, building managers, or pest control technicians to detect, track, and document insect population levels over time. Example systems and methods can also assist in verifying and validating the killing effectiveness of other pest control programs such as chemical sprays, baits, heaters, steam treatments, and the like.

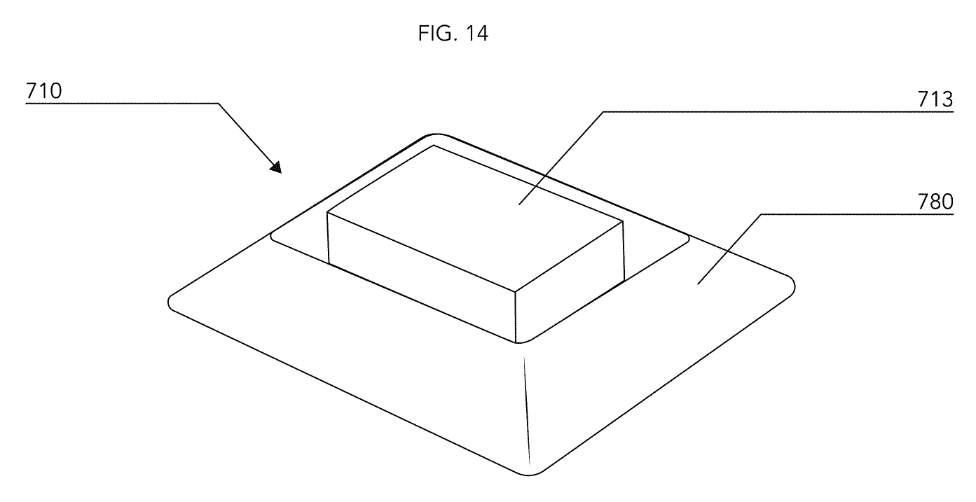

Example systems, including those described herein, can improve the effective surface area of a monitor or trap by avoiding or limiting the use of beads of PSA in traps, where such configurations may limit the effectiveness in trapping insects and may waste PSA. Example embodiments can include wide openings and can eliminate ramps and other barriers that may require additional effort for insects to enter a trap. Insects may naturally follow the path of least resistance and may veer away when encountering such obstacles. It will be appreciated that embodiments are described by way of example only, where ramps (as shown, for example, in FIGS. 14-16), barriers, texturing, or other designs or features are contemplated if such a configuration is desirable for a particular application. Example embodiments can include a low ceiling, where a low ceiling design may encourage insects to gather, cluster or nest within the interior of the trap, monitor, or detection system.

Example systems can include adhesive on multiple surfaces, where applying adhesive to only one surface may limit the useable orientation of a trap or monitor. For example, providing a single adhesive surface may make a trap ineffective when used upside down and only minimally effective if oriented vertically. Adhesive mounting strips can also be positioned on the exterior of a trap or monitor, which can make the trap or monitor useful in a wide variety of applications other than simply resting on a flat surface. Example embodiments can be coated on part or substantially all of the exterior of a trap with adhesive, where such traps can be omni-directional and can include a peel and stick backing that can make such traps equally effective for application at any angle on any surface. It will be appreciated that any combination of adhesive, PSA, insect attractant, design, and configuration is contemplated.

Example embodiments can include closed designs that can reduce or eliminate exposed adhesive trapping areas such that, when traps are placed in situ, the likelihood that such surfaces can be touched or interfered with by adults, children, or pets is reduced. Such embodiments may also have a longer effective life as exposed adhesive can quickly become ineffective due to other outside factors, such as ambient dust.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Described herein are example embodiments of apparatuses, systems, and methods for insect detection, extermination, trapping, or monitoring. In one example embodiment, a trap can be provided that can both attract and trap insects. In some embodiments, a trap can be provided that can attract insects, such as bedbugs, using carbon dioxide or heat. In some embodiments, a trap can be provided that can trap insects such as bedbugs using a PSA (pressure sensitive adhesive). Certain embodiments can include an insect monitoring device that can trap and hold insects in a viewable housing with internal coatings of non-drying adhesives or PSA.

The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Example systems described herein can optimize the height dimension within a monitor trap to leverage the natural instinct of target insects to cluster together in tight spaces, which can make the traps attractive as a nesting and harboring space. Example embodiments can allow for viewing of entrapped insects by the use of optically clear PSA or optically clear construct films. Example embodiments can include an open perimeter design that can have central support spacers that can allow 360 degrees of access by insects, where such embodiments may eliminate access deterrents such as climbing ramps or narrowed openings. Embodiments can include an omni-directional trap design, which can allow for a wide variety of trap placement options in any plane of orientation. Example embodiments can include a relatively large surface area of the PSA entrapment glues. Example embodiments can eliminate or reduce a user's contact with PSA glues or trapped insects before, during, or after use. Example embodiments can include a simple construction and design that can use design for manufacture principles that can enable high-speed production and may reduce manufacturing costs.

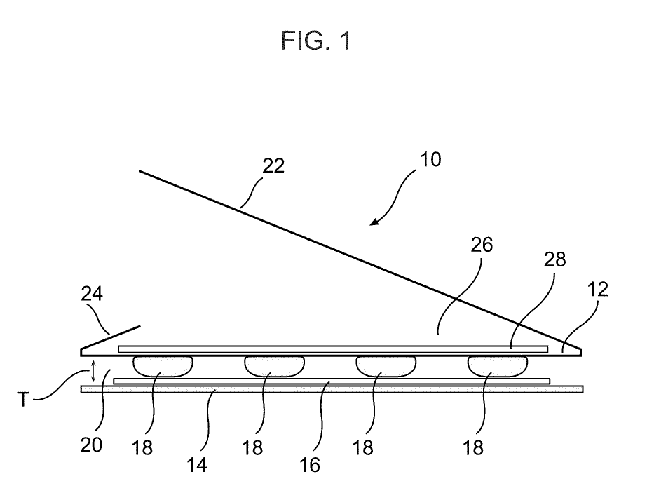

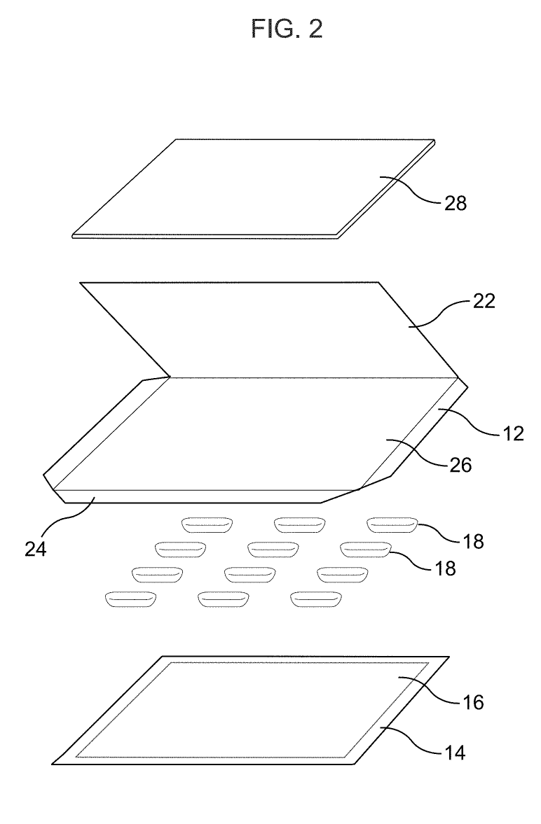

Referring now to FIGS. 1 and 2, shown is an example embodiment of a trap 10 that can be used for the trapping, exterminating, detecting, or monitoring of various insect species infestations, particularly bedbugs. The trap 10 can include a first planar surface 12 and a second planar surface 14, where the first planar surface 12 and the second planar surface 14 can be spaced-apart parallel planes of substrate separated by a plurality of spacers 18. The first planar surface 12 or the second planar surface 14 can include a coating 16 of pressure sensitive adhesive (PSA) or any suitable adhesive, attractant, insecticide, material, or combinations thereof, where the coating 16 can be located on an inner surface of the second planar surface 14. The spacing between the first planar surface 12 and the second planar surface 14 can be optimized as an attractant for a target insect species to leverage the natural instinct of many insects to cluster or nest together within tight enclosed spaces. For example, the spacing between the first planar surface and the second planar surface can be from about 1 mm to about 7 mm in distance, from about 5 mm to about 6 mm in distance, or from about 2 mm to about 4mm in distance. Spacing can also be adjusted to target a suitable stage in an insect lifecycle. Any suitable number of spacers 18 having any suitable configuration is contemplated, where the spacers 18 can also function to couple the first planar surface 12 with the second planar surface 14. Example configurations of the spacers 18 can include three-dimensional dots or dashes, spheres, columns, cubes, porous tubes of carbon dioxide-emitting material, dots or ribs that can protrude from one or both planar surfaces, corrugated or embossed layers between the two planar surfaces, porous webs, scrims, or combinations thereof.

In an example embodiment, the first planar surface 12 can include a retention flap 22 and flange 24, such that the retention flap 22 can selectively engage the flange 24 to define a pouch, cavity, or compartment 26 in combination with the first planar surface 12. The compartment 26 can be configured to retain an insect attractant such as, for example, an attractant pad 28 that can be selectively removable from the compartment 26. The attractant pad 28 can include a carbon dioxide generating material where, in an example embodiment, the attractant pad 28 can be wetted by a user to activate the carbon dioxide generating material before inserting the attractant pad 28 into the compartment 26. Combinations that can be used to create carbon dioxide can include yeast fermentation, combining yeast, sugar and water in a fermenting process, combining baking soda and vinegar, combining bicarbonates and water, combining citric acid flakes, baking soda and water, melting dry ice, combining calcium carbonate with an acid, using fungus for microbial fermentation of carbon dioxide, reducing iron from its oxides (exothermic rust formation), combining hydrochloric acid with limestone or chalk (calcium carbonate), or combinations thereof. Other chemicals or compounds such as sugars or pheromones can also be used or can be used independently.

The attractant pad 28 can be selectively removable from the trap 10 such that multiple attractant pads 28 can be used with the same trap 10 over time. Carbon dioxide is an attractant for many insects, where including an attractant pad 28 may draw insects into the trap 10 for capture on the coating 16. It will be appreciated that any suitable attractant is contemplated including chemical attractants, pheromones, or heat. In an example embodiment, the attractant pad can include a heating element, such as a heating element that is activated when exposed to air, to draw insects into a trap. It will be appreciated that any suitable number of attractant pads 28, compartments 26, materials, or the like are contemplated in any suitable configuration. Such attractant pads 28 can be specific for a particular species of insect or can be broad spectrum.

In one example, a coating can be placed on a first planar surface, a second planar surface, and a plurality of spacers, which can allow for the entire interior surface of the trap to be used as a trapping surface for insects and can reduce or eliminate exposed PSA on the exterior of the trap. In an example embodiment, the trap 10 can be easily placed across a broad range of locations and orientations such as under mattresses, between couch cushions, behind pictures and headboards, on bedframes and furniture legs, inside luggage or drawers, etc. The trap 10, in one embodiment, can be easily handled without the user contacting any PSA, or other active or adhesive material, which may make the trap 10 appealing to users with children or pets.

The trap 10 can be configured with a low-profile and an open edge design which can allow insects to enter the trap 10 from any point around the perimeter without the need to climb up ramps or seek out openings within the trap. In an example embodiment, the first planar surface 12 and the second planar surface 14 can be an optically clear film and the coating 16 can be an optically clear PSA. The trap 10 can be transparent or substantially transparent, which can facilitate the early detection and monitoring of target insects in situ. Such a configuration may allow for the improved viewing and documenting of insects trapped in situ from multiple perspectives, including close examination under a microscope without requiring the user to have any direct exposure or contact with insects.

The trap 10 can have a substantially hollow construction having a closely spaced parallel first planar surface 12 and second planar surface 14, separated by a plurality of spacers 18, which can create a multiplicity of narrow nesting spaces for insect colonies. The spacing between the first planar surface 12 and the second planar surface 14 can be adjusted during fabrication to be optimized for attracting specific target insect species by leveraging the natural instinct of harboring together and nesting within tight enclosed spaces. Any suitable number and configuration of spacers 18 is contemplated. The trap 10 can have a substantially uniform thickness or, in an alternate embodiment, can have a variable or user-adjusted thickness where, for example, the spacers 18 can be telescoping members allowing for a range of thicknesses.

The trap 10 can include a low profile and narrow perimeter entry gap 20, having a thickness “T”, that can allow insects unrestricted access around the entire exterior perimeter of the monitor or trap 10, which can offer the insects 360 degrees of access without the need to climb up inclines or entry ramps. The narrow perimeter entry gap can also prevent any unwanted or accidental contact with the adhesives or coating 16 by adults, children, pets or the like. In an example embodiment, by optimizing the narrow perimeter entry gap 20, the exposure of the coating 16 to ambient air currents can be minimized which can reduce exposure of the coating 16 to airborne dust or contaminants that may cause a loss of the beneficial properties of the coating 16.

In an example embodiment, the trap 10 can be substantially flexible, elastic, or malleable such that the trap 10 can be shaped around curves, corners, or complex shapes, where the trap 10 can be deployed as an effective perimeter barrier for furniture, bed frames, chair legs, cabinetry, doorways, windows, baseboards and the like. In an example embodiment, the trap 10 can have an elongate flexible configuration the can allow the trap 10 to be placed substantially within the entire gap underneath a door.

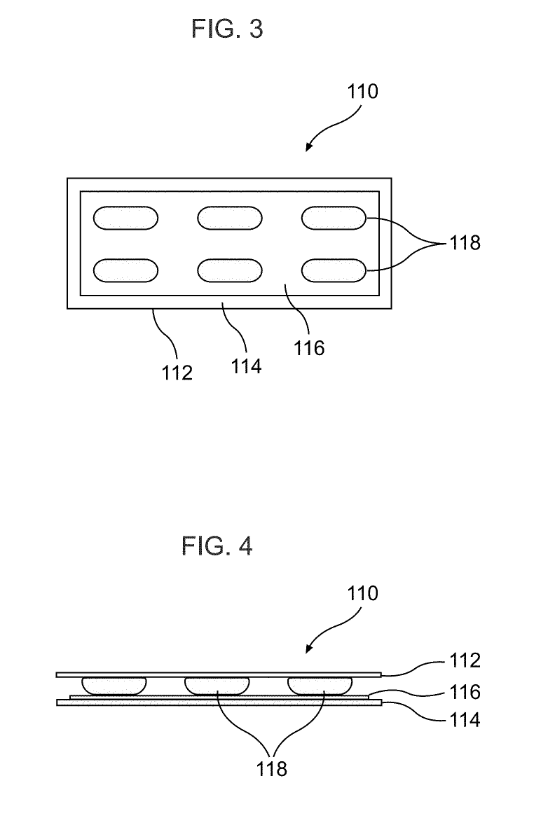

Referring to FIGS. 3 and 4 an example embodiment of a trap 110 is shown that can include a first planar surface 112, a second planar surface 114, a plurality of spacers 118, and a coating 116. In the illustrated embodiment, the first planar surface 112, the second planar surface 114, and the plurality of spacers 118 can be configured from a substantially transparent material. The trap can be, for example, 1.25 inches wide and 3 inches in length, although any suitable dimensions are contemplated. The second planar surface 114 can include a perimeter around the coating 116, where the perimeter may not contain adhesive, PSA, or other materials. The perimeter may reduce the likelihood that a user will come into contact with the coating 116.

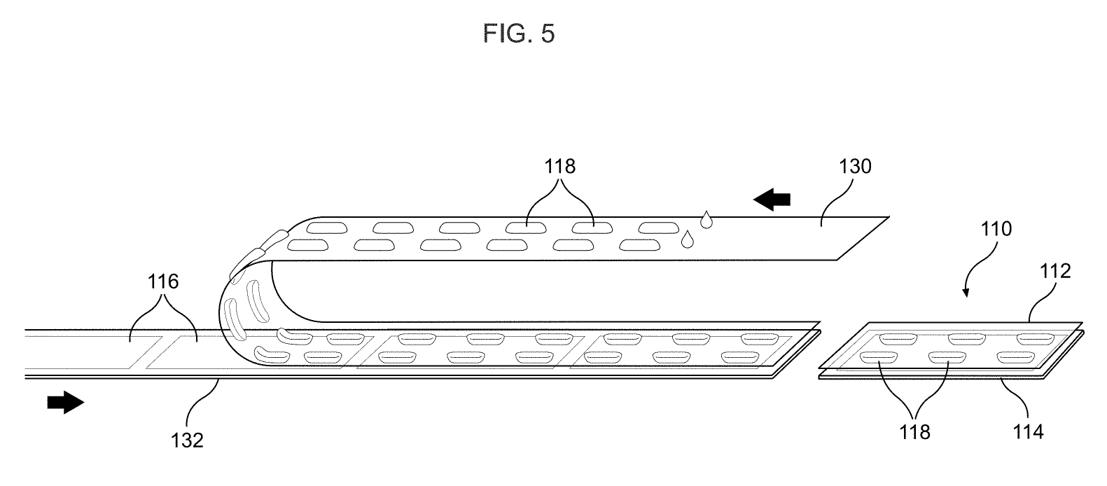

Referring to FIG. 5, one example of a method of manufacturing the trap 110 is illustrated. A first sheet 130 of clear film can be provided that can be extruded or otherwise manufactured on a large scale. The first sheet 130 can be cut, at the completion of the manufacturing process, such to create a plurality of first planar surfaces 112. The first sheet 130 can have a plurality of spacers 118, which can be formed from hot melt glue or other flowable material, applied to the first sheet 132 by any suitable machine or system. A second sheet 132 of white card stock or film can be provided that can be extruded or otherwise manufactured on a large scale. The second sheet 132 can be cut, at the completion of the manufacturing process to create a plurality of second planar surfaces 114. A plurality of coatings 116 can be applied to the second sheet 132, such as in spaced apart generally rectangular-shaped configurations, that can function as the coating 116 in the finished trap 110. In an example embodiment, the first sheet 130 and the second sheet 132 can be adhered to one another by spacers 118 partially melted during production, where the first sheet 130 and the second sheet 132 can be substantially affixed to one another when the spacers 118 harden. A cutting device (not shown) can then separate the first sheet 130 and the attached second sheet 132 into a plurality of traps 110.

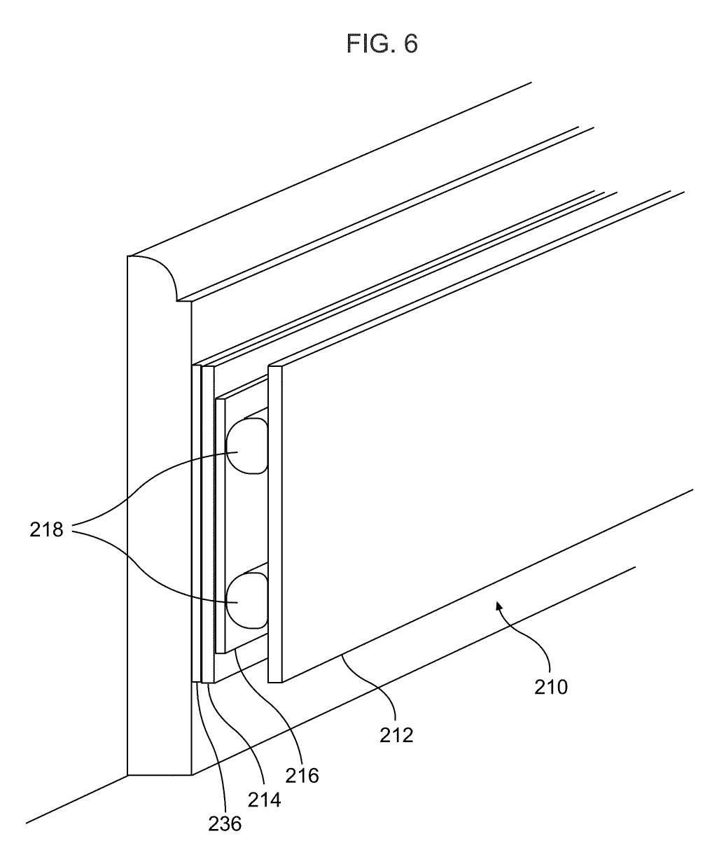

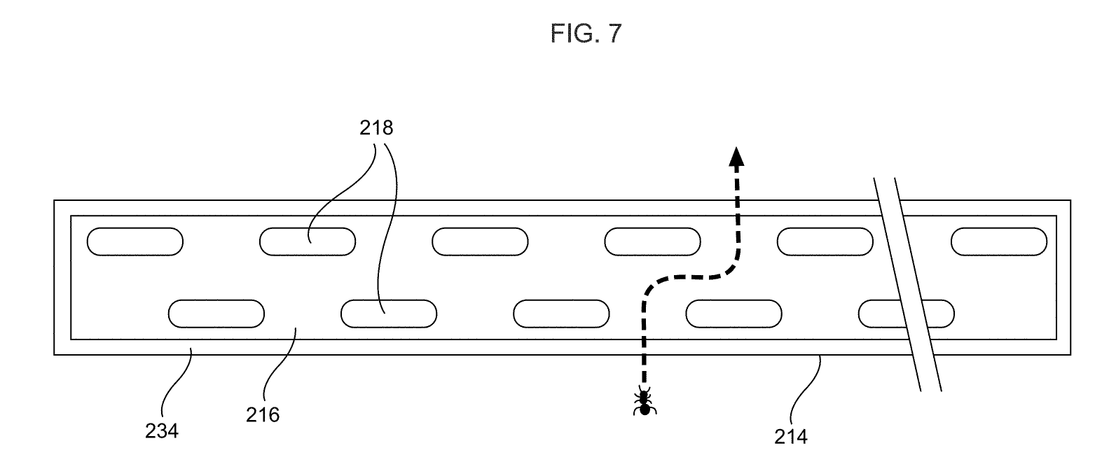

Referring now to FIGS. 6 and 7, one example of a barrier 210 is illustrated that can include a first planar surface 212 that can be affixed to a second planar surface 214 with a plurality of spacers 218. That second planar surface 214 can include a coating 216 that can have an adhesive, attractant, or other suitably impregnated surface, material, or chemical. The barrier 210 can be configured for placement in door frames or other suitable locations to help prevent the migration of insects such as bedbugs. In an example embodiment, the barrier 210 can have a width of 1.25 inches and a length of 48 inches, although any suitable length is contemplated. In an example embodiment, a user can purchase a relative long sheet of barrier 210 that can be cut by the user to a desirable length. The barrier 210 can include staggered spacers 218 (FIG. 7) that may further impede the progress of insects through the barrier 210. The barrier 210 can include a non-adhesive perimeter 234 that can facilitate handling of the barrier 210 without contacting the coating 216. Referring to FIG. 6, the second planar surface 214 can also include an adhesive 236, such as a peel-and-stick adhesive, on the bottom surface thereof, such that a user can attach the trap 210 to a wall or other surface. The adhesive 236 may have a paper coating (not shown) that can be removed by a user before attaching the barrier 210 to any suitable surface.

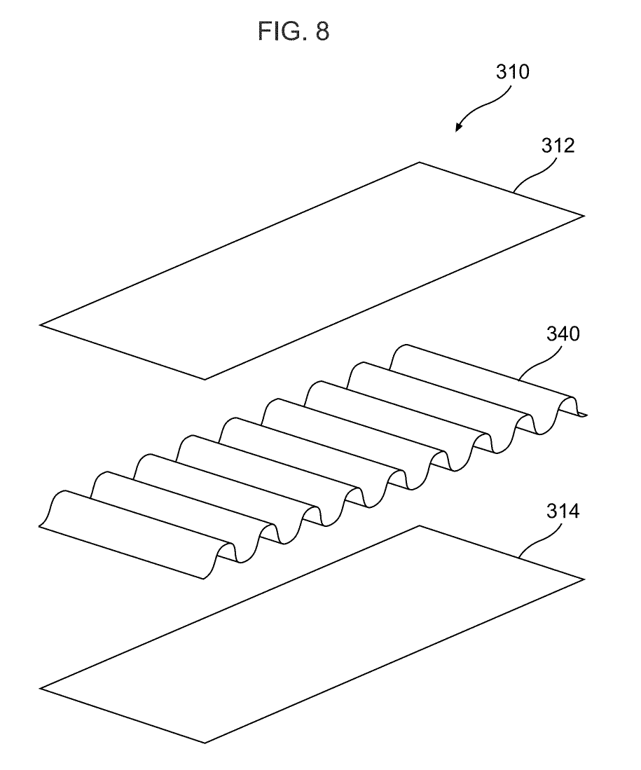

Referring to FIG. 8, an alternate embodiment of a trap 310 is illustrated that can include a first planar surface 312 and a second planar surface 314 that can be coupled together with a corrugated or waveform adhesive 340. The waveform adhesive 340 can suitably space apart the first planar surface 312 and the second planar surface 314 and the waveform adhesive 340 can be impregnated with PSA or another suitable material to capture insects passing through the trap 310.

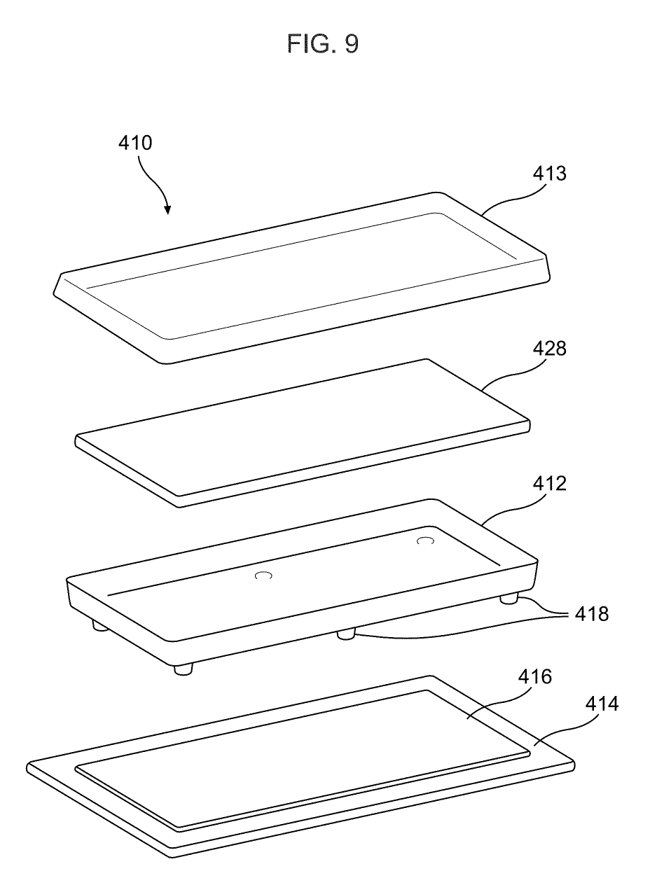

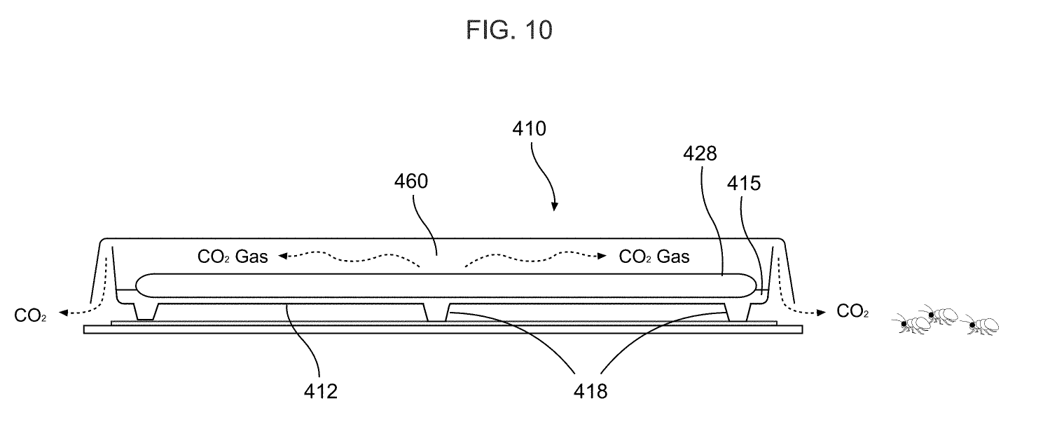

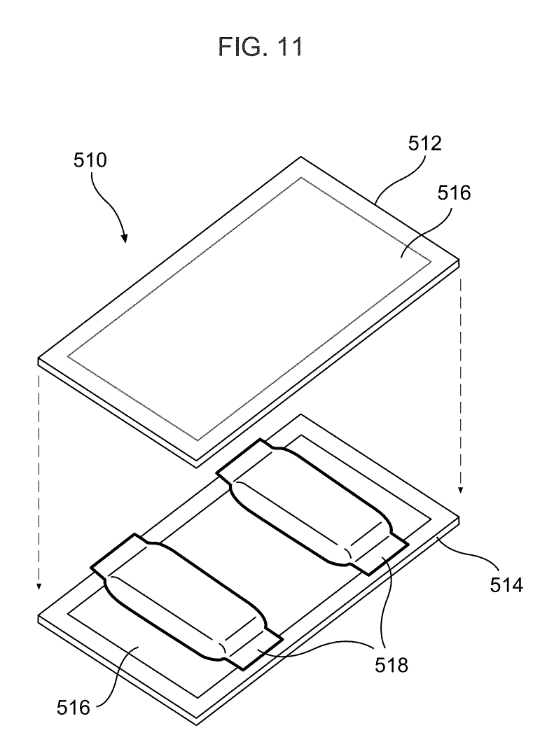

Referring to FIGS. 9 and 10, an alternate embodiment of a trap 410 is illustrated that can include a tray 412 that can define a compartment 460 (FIG. 10) in combination with a dome 413. The compartment 460 can be configured to selectively retain one or a plurality of attractant pads 428, where the attractant pads 428 can be configured to generate carbon dioxide, heat, or the like. Referring to FIG. 10, the tray 412 can be at least partially filled with a fluid 415, such as water, that can activate the one or a plurality of attractant pads 428. The tray 412 can include a plurality of feet or spacers 418 that can be configured to engage a planar surface 414 that can include a coating 416 of PSA or adhesive. In an example embodiment, the spacers 418 of the tray 412 can be permanently affixed to the planar surface 414. In an example embodiment, the dome 413 can be selectively removable, such as with a snap fit, from the tray 412 such that a user can remove the dome 413, insert one or a plurality of attractant pads 428 into the compartment 460, insert a liquid 415, and reattach the dome 413. The dome 413 can be affixed to the tray 412 in a non-airtight configuration such that gases, such as carbon dioxide, can emanate from the trap 410 when the one or a plurality of attractant pads 428 is activated.

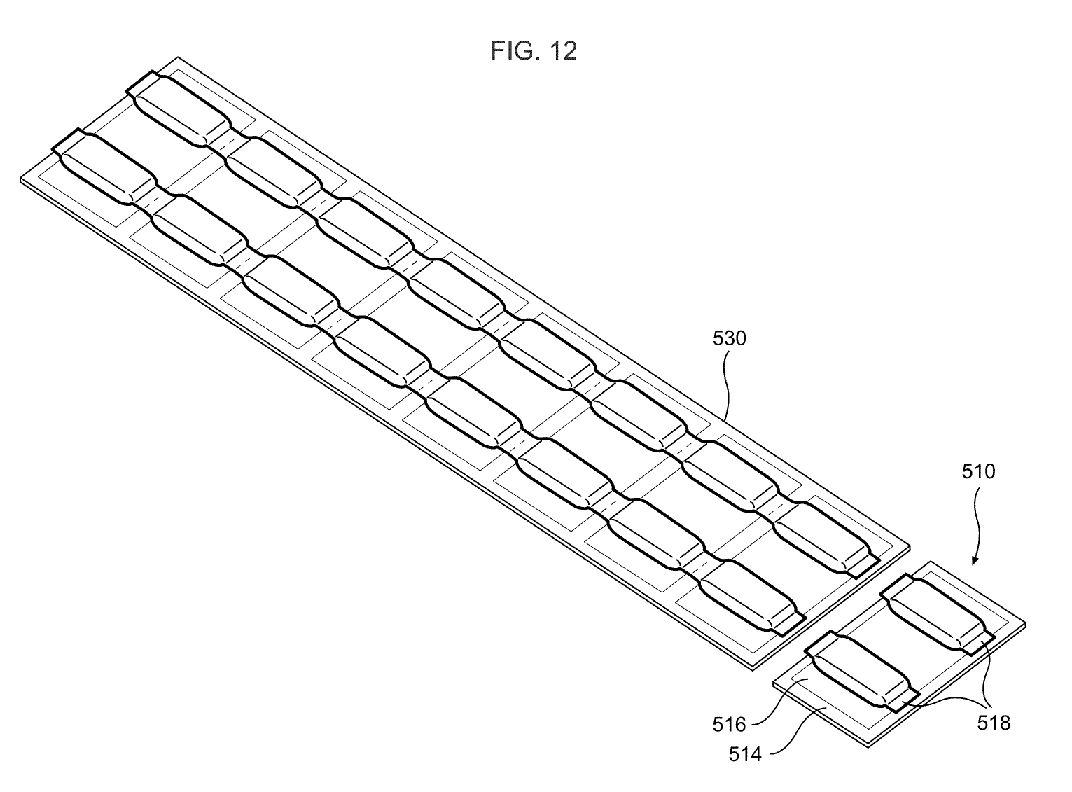

Referring to FIGS. 11 and 12, an alternate embodiment of a trap 510 is illustrated, where the trap 510 can include a first planar surface 512, a second planar surface 514, and one or a plurality of attractant pouches 518 spaced therebetween. The first planar surface 512 and the second planar surface 514 can include a coating 516 of adhesive or PSA. In an example embodiment, the pouches 518 can be porous or otherwise non-airtight such that an attractant can emanate through the pouches 518. The pouches can retain a chemical, solution, or mixture, for example, that exudes carbon dioxide when exposed to fluids such as water. The pouches 518 can be for example 1.5 inches long and 0.5 wide. The first planar surface 512 and the second planar surface 514 can be spaced apart by a predetermined distance such as 5.2 mm, for example. The trap 510 can be 1.5 inches wide and 3 inches long. The pouches 518 can include an adhesive that can couple the first planar surface 512 with the second planar surface 514, or alternatively can be attached to the coatings 516 on the first planar surface 512 and the second planar surface 514. The pouches 518 can include a gaseous attractant, can give off heat, can include bait, or otherwise attract insects. In an example embodiment, the pouches 518 can be configured to produce attractant for from about seven to about ten days, although any suitable useful life is contemplated. In an example embodiment, the pouches 518 can be activated with water and can include an adhesive surface that is hydrophobic such that the trap 510 can shed water with no impact on the adhesive surface's functionality.

Referring to FIG. 12, one example of a method of manufacturing the trap 510 is illustrated. A first sheet 530 of clear film can be provided that can be extruded or otherwise manufactured on a large scale. The first sheet 530 can be cut, at the completion of the manufacturing process, such as to create a plurality of first planar surfaces 512 (e.g., see FIG. 11). A plurality of attractant pouches 518, which can be can be affixed to one another in series prior to a final cutting step, can be placed along the first sheet 530. A second sheet (not shown) film can be provided that can be extruded or otherwise manufactured on a large scale. The second sheet can be cut, at the completion of the manufacturing process to create a plurality of second planar surfaces 514. A plurality of coatings 516 can be applied to the second sheet and the first sheet 530, such as in spaced apart generally rectangle-shaped configurations that can function as the coatings 516 in the finished trap 510. A cutting device (not shown) can then separate the first sheet 530 and the attached second sheet into a plurality of traps 510.

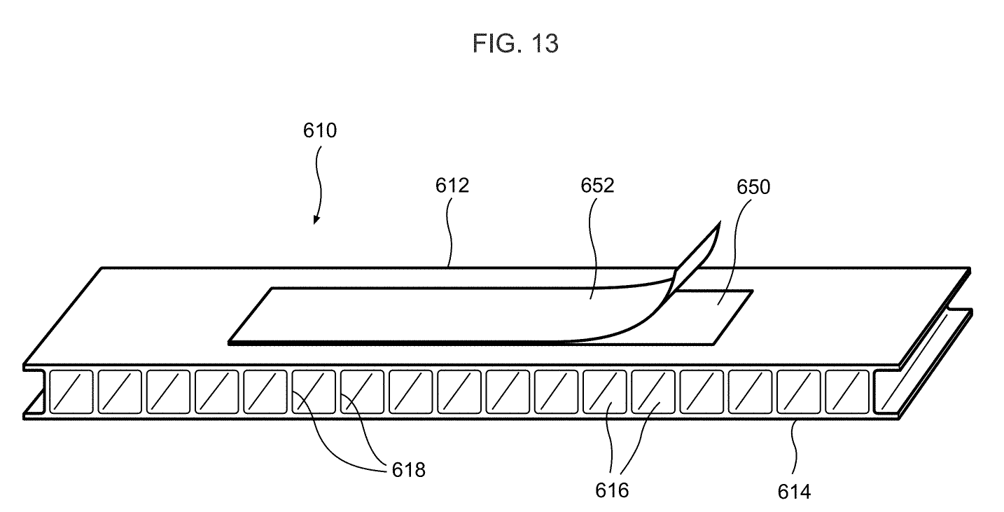

Referring to FIG. 13, shown is an example embodiment of a trap 610 that can be used for the trapping, exterminating, detecting, or monitoring of various insect species infestations, particularly bedbugs. The trap 610 can include a first planar surface 612 and a second planar surface 614, where the first planar surface 612 and the second planar surface 614 can be spaced-apart parallel planes of substrate separated by a plurality of spacers 618. The first planar surface 612 or the second planar surface 614 can include a coating 616 of pressure sensitive adhesive (PSA) or any suitable adhesive, attractant, insecticide, coating, material, or combinations thereof, where the coating 616 can be located on an inner surface of the second planar surface 14. The spacing between the first planar surface 612 and the second planar surface 614 can be optimized as an attractant for a target insect species to leverage the natural instinct of many insects to cluster or nest together within tight enclosed spaces. For example, the spacing between the first planar surface 612 and the second planar surface 614 can be from about 1 mm to about 7 mm in height, from about 5 mm to about 6 mm in height, or from about 2 mm to about 4mm in height. Spacing can also be adjusted to target a suitable stage in an insect lifecycle. Any suitable number of spacers 618 having any suitable configuration is contemplated, where the spacers 618 can also function to couple the first planar surface 612 with the second planar surface 614. In an example embodiment, the first planar surface 612, the second planar surface 614, and the spacers 618 can be integral where, for example, the trap 610 can be a single extrusion, mold, or the like. The trap 610 can include an attachment surface 650 that can be covered by a selectively removable film 652, where the attachment surface 650 can be configured to attach the trap 610 to any suitable surface when the removable film 652 is removed. It will be appreciated that the attachment surface 650 can include any suitable adhesive and that any other attachment, such as magnets or a hook and loop fastener, is contemplated. It will be appreciated that the attachment surface 650 can be positioned at any location on the trap 610 and can be used to attach the trap 610 to any suitable surface.

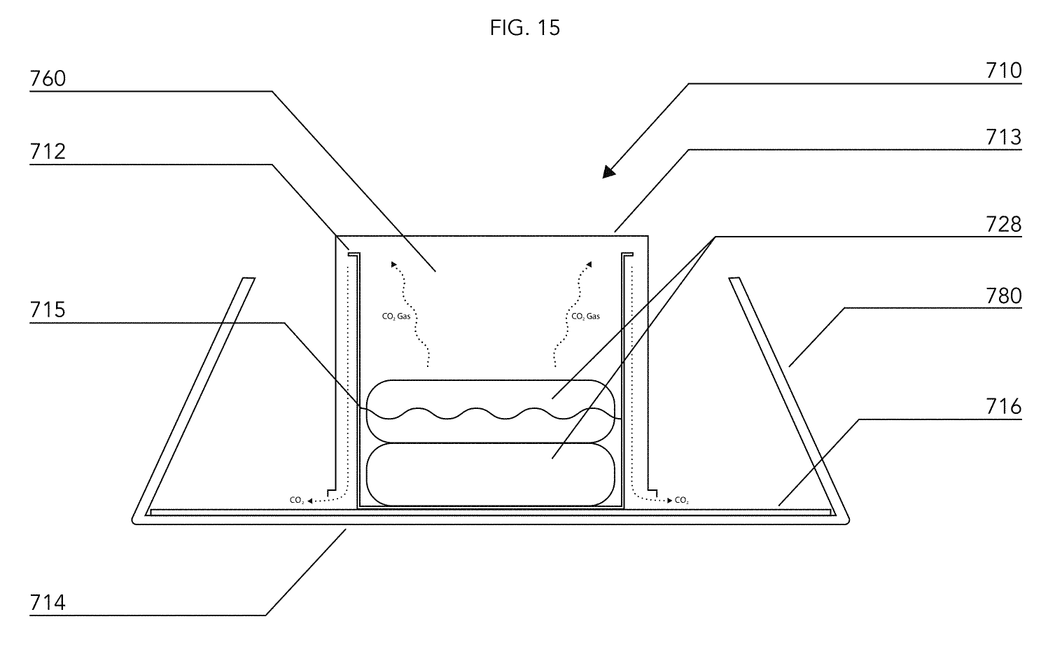

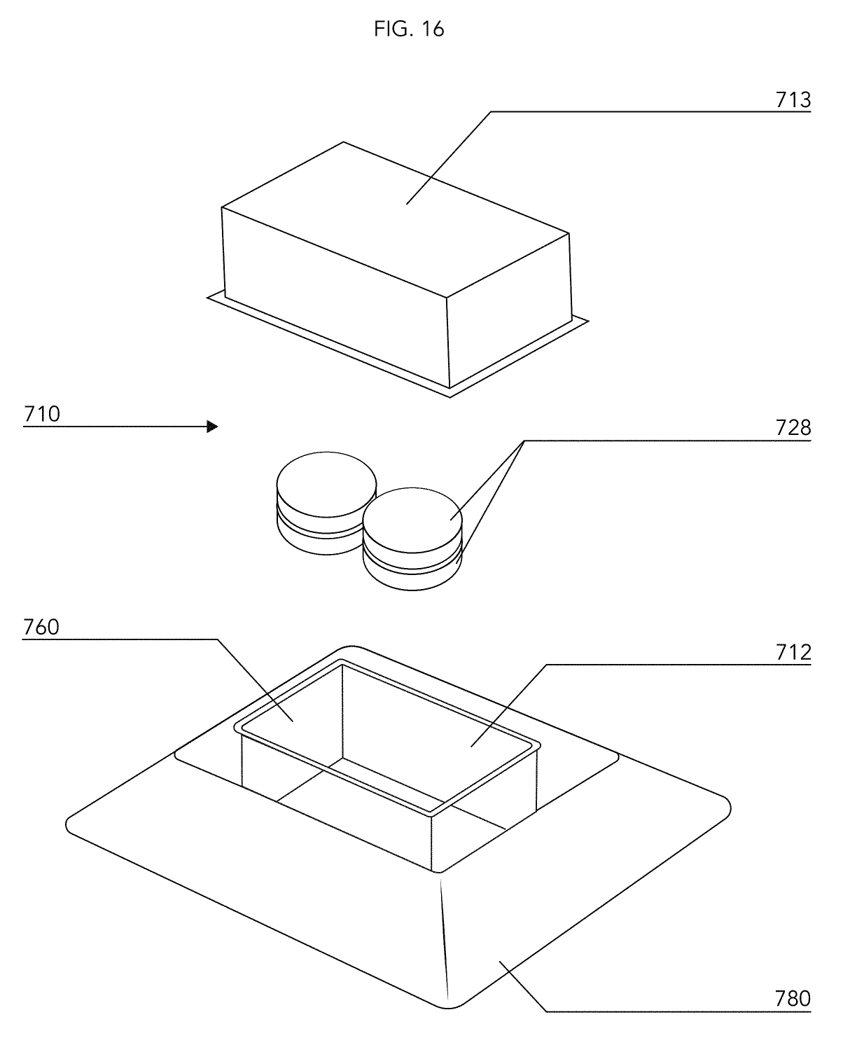

Referring to FIGS. 14-16, an alternate embodiment of a trap 710 is illustrated that can include a tray 712 that can define a compartment 760 (FIGS. 15 and 16) in combination with a dome 713. The compartment 760 can be configured to selectively retain one or a plurality of attractant elements 728, where the attractant elements 728 can be configured to generate carbon dioxide, heat, or the like. Referring to FIG. 15, the tray 712 can be at least partially filled with a fluid 715, such as water, that can activate the one or a plurality of attractant elements 728. The tray 712 can engage a planar surface 714 that can include a coating 716 of PSA or adhesive. In an example embodiment, a ramp 780 can be associated with the planar surface 714. In an example embodiment, the dome 713 can be selectively removable, such as with a snap fit, from the tray 712 such that a user can remove the dome 713, insert one or a plurality of attractant elements 728 into the compartment 760, insert a liquid 715, and reattach the dome 713. The dome 713 can be affixed to the tray 712 in a non-airtight configuration such that gases, such as carbon dioxide, can emanate from the trap 710 when the one or a plurality of attractant elements 728 is activated.

In general, it will be apparent to one of ordinary skill in the art that at least some of the embodiments described herein can be implemented in many different embodiments of hardware, features, and materials. The materials, hardware, and configurations that can be used to implement embodiments is not limiting. For example, embodiments described herein can be implemented using any suitable materials, adhesives, coatings, and can be assembled using any suitable manufacturing system or method.

In various embodiments disclosed herein, a single component can be replaced by multiple components and multiple components can be replaced by a single component to perform a given function or functions. Except where such substitution would not be operative, such substitution is within the intended scope of the embodiments. Some of the figures can include a flow diagram. Although such figures can include a particular logic flow, it can be appreciated that the logic flow merely provides an exemplary implementation of the general functionality. Further, the logic flow does not necessarily have to be executed in the order presented unless otherwise indicated.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

We claim:

1. A bed bug trap comprising:
a. a housing, the housing having a planar surface, wherein at least a portion of the planar surface includes a pressure sensitive adhesive for the entrapment of bed bugs;
b. a ramp, the ramp being associated with a perimeter of the planar surface, wherein the ramp facilitates omni-directional access into the housing;
c. a tray, d. a dome, the dome being selectively removable from the tray, wherein the dome and the tray cooperate to define a compartment;
e. an attractant element, the attractant element being a chemical mixture that exudes carbon dioxide, wherein the attractant element is selectively placed within the compartment defined by the tray and dome.

2. The bed bug trap of claim 1, wherein the tray is coupled with the dome in a snap fit.

3. The bed bug trap of claim 1, wherein the dome is not airtight such that carbon dioxide can escape from the compartment.

4. The bed bug trap of claim 1, wherein the compartment is sized to receive a plurality of selectively removable attractant elements.

5. The bed bug trap of claim 1, wherein the attractant element is initiated with a fluid.

6. The bed bug trap of claim 5, wherein the fluid is selected from the group consisting of water, citric acid, sodium bicarbonate, and combinations thereof.

7. The bed bug trap of claim 1, wherein the attractant element generates heat.

8. The bed bug trap of claim 1, wherein the attractant includes pheromones.

9. The bed bug trap of claim 1, wherein the housing is substantially closed such that access to the pressure sensitive adhesive by a user is limited.

10. The bed bug trap of claim 1, wherein the housing is transparent.

11. The bed bug trap of claim 1, wherein the attractant element is selected from the group consisting of a pad, a pouch, a chemical, a solution, a gaseous attractant, a mixture, and combinations thereof.

12. The bed bug trap of claim 1, wherein the housing includes an adhesive for attachment to a location.

13. The bed bug trap of claim 1, wherein the attractant element has an effective life of from about seven to about ten days.

14. A bed bug trap comprising:
a. a housing, the housing having an adhesive surface, wherein at least a portion of the adhesive surface includes a pressure sensitive adhesive for the entrapment of bed bugs;
b. a ramp, the ramp being associated with a perimeter of the adhesive surface, wherein the ramp facilitates omni-directional access into the housing;
c. a dome, the dome being coupled with the housing, wherein the dome defines a compartment;
d. an attractant element, the attractant element being configured to generate carbon dioxide, wherein the attractant element is retained within the compartment defined by the dome.

15. The bed bug trap of claim 14, wherein the dome is positioned inside the perimeter of the adhesive surface.

16. The bed bug trap of claim 14, wherein the attractant element is selected from the group consisting of a pad, a pouch, a chemical, a solution, gaseous attractant, a mixture, and combinations thereof.

17. The bed bug trap of claim 14, wherein the dome is fixedly coupled with the housing.

18. A bed bug trap comprising:
a. a housing, the housing having an adhesive surface, wherein at least a portion of the adhesive surface includes a pressure sensitive adhesive for the entrapment of bed bugs;
b. a ramp, the ramp being associated with a perimeter of the adhesive surface, wherein the ramp facilitates access into the housing;
c. a dome, the dome being coupled with the housing, wherein the dome defines a compartment;
d. a plurality of attractant elements, the plurality of attractant elements being configured to generate carbon dioxide, wherein the plurality of attractant elements are retained within the compartment defined by the dome.

19. The bed bug trap of claim 18, wherein the plurality of attractant elements are selected from the group consisting of a pad, a pouch, a chemical, a solution, gaseous attractant, a mixture, and combinations thereof.

20. The bed bug trap of claim 18, wherein the dome is not airtight such that carbon dioxide can escape from the compartment.
